(19) United States
(12) Patent Application Publication
(10) Pub. No.: US 2026/0157273 A1
(43) Pub. Date: Jun. 11, 2026

(54) LAWN TRIMMER AND EDGER

(71) Applicant: William J. Foster, Akron, OH (US)

(72) Inventor: William J. Foster, Akron, OH (US)

(21) Appl. No.: 18/975,266

(22) Filed: Dec. 10, 2024

(51) Int. Cl. A01D 34/84; A01D 34/00

(52) U.S. Cl. CPC A01D 34/84; A01D 34/001

(57) ABSTRACT

A trimmer and edger apparatus for cutting or removing vegetation such as grass and/or weeds includes a housing supporting a forward cutting head and a rear cutting head, with the trimmer and edger apparatus having an adjustable shaft, a handle, a power control unit for actuating the cutting heads, laser light illumination, and an adjustable guide wheel which conjunctively enhance ergonomics and safety.

### I. RELATED APPLICATIONS

There are no previously filed, nor currently any co-pending applications, anywhere in the world.

### II. FIELD OF THE INVENTION

This application discloses claims and embodiments generally related to a lawn or vegetation trimmer, and in particular, a trimmer and edger apparatus comprising multiple cutting heads, a straight edge, and an illumination guide for precision cutting.

### III. BACKGROUND OF THE INVENTION

Numerous attempts have been made to improve law trimmers. One such device is described in U.S. Pat. No. 6,996,960 (issued to Flemm) for a “Grass Trimming Device with Dual Linehead Spool Hubs” and that describes a grass trimming device adapted to simultaneously trim grass at both a substantially horizontal plane and a substantially vertical plane. The device includes actuation switches that allow linehead spool hubs to be used in an independent manner.

U.S. Pat. No. 10,939,612 (issued to Lab) for a “Weed Wacker” discloses a mono-filament whip type weed cutter and includes two interconnected first and second trimmer support shafts, a rotating wheel connected to one end of the pivotable shaft, and a power source connected to an opposite end of the pivotable shaft.

U.S. Pat. No. 11,369,057 (issued to Palermo et al.) for a “String Trimmer with Pole Break” discloses a string trimmer having a hinged pole for folding the string trimmer, the hinge having a lock that allows for repeated folding of the trimmer for easy transport and storage, and a battery at a rear end of the pole near the handle, and a motor at a front end on the cutting head.

Accordingly, a need exists for an improved vegetation trimmer.

### IV. SUMMARY OF THE INVENTION

In one embodiment, a trimmer and edger device comprises a housing supporting a forward cutting head and a rear cutting head, wherein at least one cutting head is adjustable between a horizontal orientation and a vertical orientation, an elongated and adjustable shaft depending from the housing, a handle depending from the adjustable shaft, and, a power control unit depending from the adjustable shaft, the handle disposed inferiorly to the power control unit.

In another embodiment, a trimmer and edger device comprises a housing supporting a forward cutting head and a rear cutting head, wherein at least one cutting head is adjustable between a horizontal orientation and a vertical orientation, an elongated and adjustable shaft depending from the housing, a handle depending from the adjustable shaft, a power control unit depending from the adjustable shaft, the handle disposed inferiorly to the power control unit, and, a guidewheel assembly depending from the adjustable shaft.

In another embodiment, a trimmer and edger device comprises a housing supporting a forward cutting head and a rear cutting head, wherein at least one cutting head is adjustable between a horizontal orientation and a vertical orientation, an elongated and adjustable shaft depending from the housing, a handle depending from the adjustable shaft, a power control unit depending from the adjustable shaft, the handle disposed inferiorly to the power control unit, and an illuminated guide.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a side view of a trimmer and edger apparatus;

FIG. 2 is a side view of the trimmer and edger apparatus of FIG. 1 indicating articulation of the adjustable shaft through approximately 180 degrees of movement;

FIG. 2A is a front partial view of the adjustable shaft illustrating an inner vertical member telescopically arranged and movable about an outer vertical member using an adjustment means.

FIG. 3 is a perspective view of the housing, cutting heads, and adjustable guidewheel of the apparatus;

FIG. 4 is a perspective view of the housing with illumination guide, cutting heads, and adjustable guidewheel of the apparatus;

FIG. 5 is a front perspective view of the housing and cutting heads of the apparatus with the forward cutting head disposed in a horizontal orientation; and

FIG. 6 is a rear perspective view of the housing and cutting heads of the apparatus with the forward cutting head disposed in a horizontal orientation.

### VI. DETAILED DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

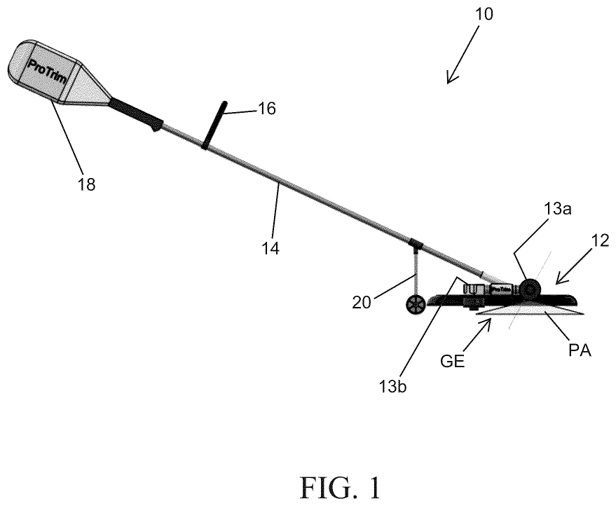

Referring now to FIG. 1 through FIG. 6, a vegetation trimmer and edger apparatus 10 is described herein. The apparatus 10 comprises a housing 12 that supports a forward cutting head 13a and a rear cutting head 13b. The apparatus 10 also comprises an elongated and adjustable shaft 14 that depends from the housing 12. The apparatus 10 also comprises a handle 16 that depends from the adjustable shaft 14. The apparatus 10 also comprises a power control unit 18 that depends from the adjustable shaft 14 with the handle 16 disposed inferiorly to the power control unit 18. The apparatus 10 may also include an illumination guide 22 for aligning one of the cutting heads 13a or 13b.

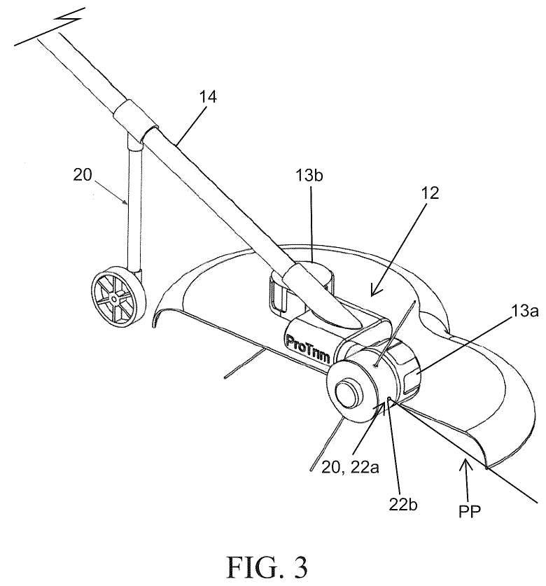

Consistent with FIG. 3 through FIG. 6, the housing 12 may comprise a variety of configurations. In one embodiment, the housing 12 comprises an enclosure having an irregular perimeter. In such an embodiment, the enclosure comprises a linearly elongated straight edge 12a that defines a portion of the enclosure's irregular perimeter. The remainder of the perimeter comprises a debris shield 12b for entrapping cut debris and protecting the user and individuals and property nearby from damage.

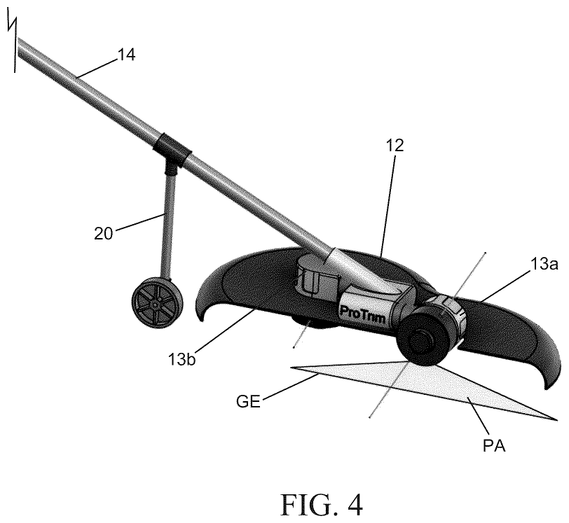

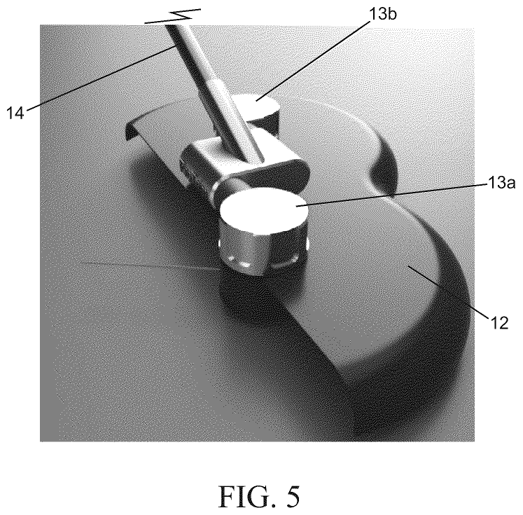

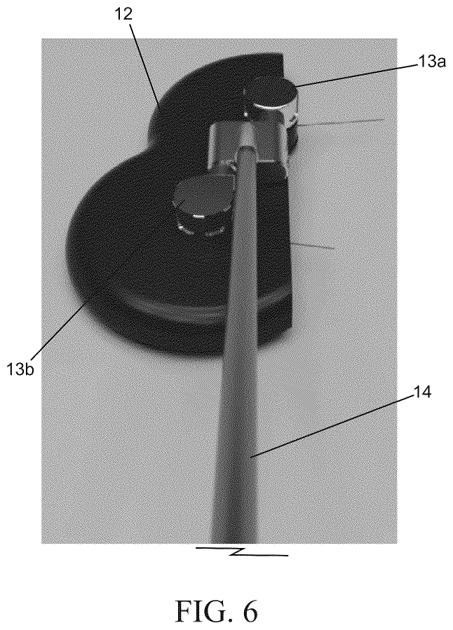

The apparatus 10 comprises a forward cutting head 13a and a rear cutting head 13b. A variety of configurations are envisioned. For example, the forward cutting head 13a is adjustable between a vertical orientation as depicted in FIG. 3 and FIG. 4 and a horizontal orientation as depicted in FIG. 5 and FIG. 6. In addition, the heads 13a and 13b may have an offset alignment relative to the disposition of the adjustable shaft 14 on the housing 12, wherein the heads 13a and 13b are off-center relative to disposition of the shaft 14. The head(s) 13a and/or 13b may utilize a variety of cutting devices, including string trimming line and/or blades of various types.

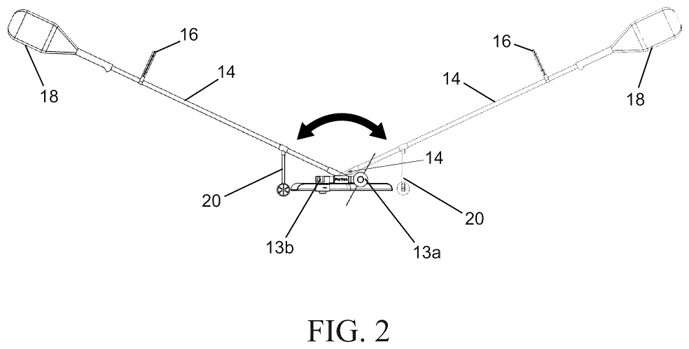

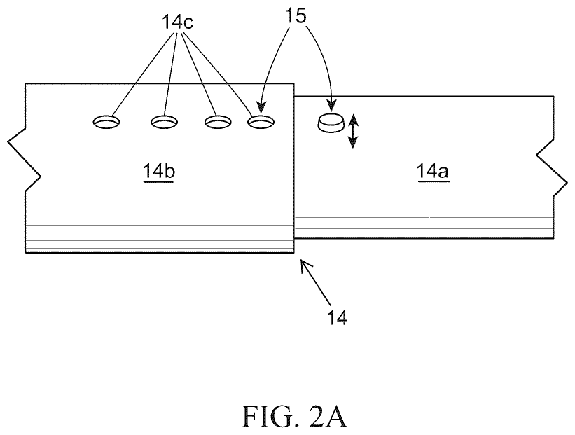

Consistent with FIG. 1 and FIG. 2, the adjustable shaft 14 terminates at one end by attachment or coupling to the housing 12 and terminates at the opposing end with the power control unit 18. Along its length, the shaft 14 comprises telescopic adjustment for lengthening and shortening the shaft 14 as needed. The adjustable shaft 14 may attach to the housing 12 via a hinge or other means for providing articulation of the shaft 14 through 180 degrees of movement. In this manner, the adjustment of shaft 14 yields an apparatus that changes the relative orientation of the straight edge 12a from a right-hand to a left-hand orientation.

As depicted in FIG. 1 and FIG. 2, the handle 16 depends from the adjustable shaft 14 and is provided to assist the user in controlling and moving the apparatus 10. The handle 16 may comprise a variety of configurations, including plastic, rubber, or combinations thereof, with molded grips and/or padding for comfort and/or ergonomic considerations. The handle 16 may be adjustable along the length of the shaft 14 and positioned in a manner that provides the most comfort and/or control to the user.

Also depicted in FIG. 1 and FIG. 2, the power control unit 18 is disposed at one terminus of the adjustable shaft 14. The unit 18 may comprise a variety of configurations, including engines fueled by battery, electricity, and/or fossil fuel(s), or even combinations thereof. The unit 18 will include the ability to start/stop the engine and any motors, motor speed, and any other controls needed.

As depicted in FIG. 1 through FIG. 4, the apparatus 10 may include further comprising an adjustable guidewheel assembly 20. The adjustable guidewheel assembly 20 depends from the adjustable shaft 14. The adjustable guidewheel assembly 20 comprises a wheel and a post depending from the wheel and coupled with the adjustable shaft 14. The adjustable guidewheel assembly 20 provides support and stability to the apparatus 10 during use, especially for generating precision trimming to beds and other landscaping areas.

Referring now to FIG. 2A, it is envisioned the shaft 14 is telescopically adjustable. In accordance to one embodiment, the shaft 14 may comprise an inner vertical member 14a and an outer vertical member 14b, wherein the inner vertical member 14a and outer vertical member 14b are adjustable and coupled via an adjustment means 15. In such an embodiment, the outer vertical member 14b has a diameter greater than the inner vertical member 14a, thereby allowing the inner vertical member 14a to adjustably slide into and out from the inner diameter of the outer vertical member 14b.

It is envisioned that a variety of adjustment means 15 may be used to achieve telescoping movement and securement, including friction impingement utilizing a depressible button outwardly biased via a spring and residing on or within the inner vertical member 14a. The button is adjustable along a plurality of indexing holes 14c provided along the outer vertical member 14b.

As depicted in FIG. 4, the apparatus 10 may include the illumination guide 22. The illumination guide 22 may comprise a variety of configurations and/or elements. For example, the guide 22 may comprise a light 22a that is coextensive to the cutting path of the forward cutting head 13a and its cutting line or cutting blade, including light via laser 22b to provide a precision path PP light, or other alternative means. Alternatively, the guide 22 may comprise a ground effect GE for illuminating the proximate area PA without the precision provided above. Alternatively, a combination of the precision path PP light and the ground effect GE may be utilized.

In use, the apparatus 10 with the forward cutting head 13a in a vertical orientation and the rear cutting head 13b in a horizontal orientation, precision edging and clearing may be accomplished with a reduction in injury and/or damage from non-standard usage (e.g., standard trimmers turned on its side exposing the cutting head and the trimmer line). The forward cutting head 13a can precisely edge the perimeter of a defined area, such as a garden bed (for residential applications) or a sand trap/bunker (for commercial applications, such as a golf course).

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A trimmer and edger apparatus comprising:
a housing supporting a forward cutting head and a rear cutting head, wherein at least one cutting head is adjustable between a horizontal orientation and a vertical orientation;
an elongated and adjustable shaft depending from the housing;
a handle depending from the adjustable shaft; and
a power control unit depending from the adjustable shaft, the handle disposed inferiorly to the power control unit.

2. The apparatus of claim 1, wherein the housing comprises an enclosure having an irregular perimeter, and wherein a linearly elongated straight edge defines a portion of the perimeter, and wherein a debris shield defines the remaining portion of the perimeter.

3. The apparatus of claim 1, wherein the adjustable shaft comprises a hinge depending from the housing, the hinge providing articulation of the adjustable shaft through 180 degrees of movement.

4. A trimmer and edger apparatus comprising:
a housing supporting a forward cutting head and a rear cutting head, wherein at least one cutting head is adjustable between a horizontal orientation and a vertical orientation;
an elongated and adjustable shaft depending from the housing;
a handle depending from the adjustable shaft;
a power control unit depending from the adjustable shaft, the handle disposed inferiorly to the power control unit; and
an adjustable guidewheel assembly depending from the adjustable shaft.

5. The apparatus of claim 4, wherein the housing comprises an enclosure having an irregular perimeter, and wherein a linearly elongated straight edge defines a portion of the perimeter, and wherein a debris shield defines the remaining portion of the perimeter.

6. The apparatus of claim 4, wherein the forward cutting head comprises means for cutting vegetation.

7. The apparatus of claim 4, wherein the rear cutting head comprises means for cutting vegetation.

8. The apparatus of claim 4, wherein the adjustable shaft comprises a hinge depending from the housing, the hinge providing articulation of the adjustable shaft through 180 degrees of movement.

9. The apparatus of claim 4, wherein the adjustable guidewheel assembly comprises a wheel and a post depending from the wheel and coupled with the adjustable shaft.

10. A trimmer and edger apparatus comprising:
a housing supporting a forward cutting head and a rear cutting head, wherein at least one cutting head is adjustable between a horizontal orientation and a vertical orientation;
an elongated and adjustable shaft depending from the housing;
a handle depending from the adjustable shaft;
a power control unit depending from the adjustable shaft, the handle disposed inferiorly to the power control unit; and
an illuminated guide.

11. The apparatus of claim 10, wherein the housing comprises an enclosure having an irregular perimeter, and wherein a linearly elongated straight edge defines a portion of the perimeter, and wherein a debris shield defines the remaining portion of the perimeter.

12. The apparatus of claim 10, wherein the forward cutting head comprises means for cutting vegetation.

13. The apparatus of claim 10, wherein the rear cutting head comprises means for cutting vegetation.

14. The apparatus of claim 10, wherein the adjustable shaft comprises a hinge depending from the housing, the hinge providing articulation of the adjustable shaft through 180 degrees of movement.

15. The apparatus of claim 10 further comprising an adjustable guidewheel assembly.

16. The apparatus of claim 15, wherein the adjustable guidewheel assembly depends from the adjustable shaft.

17. The apparatus of claim 16, wherein the adjustable guidewheel assembly comprises a wheel and a post depending from the wheel and coupled with the adjustable shaft.

18. The apparatus of claim 10, wherein the illuminated guide comprises a laser, wherein the laser provides a precision path light.
